(19) United States
(12) Patent Application Publication
(10) Pub. No.: US 2006/0243788 A1
(43) Pub. Date: Nov. 2, 2006

(54) Method and apparatus for wireless PC tablet presentation process

(76) Inventor: David Waco, Tarzana, CA (US)

Correspondence Address: DUANE MORRIS LLP, Suite 700, 1667 K Street, N.W., Washington, DC, 20006, US

(21) Appl. No.: 11/394,224

(22) Filed: Mar. 31, 2006

Related U.S. Application Data
(60) Provisional application No. 60/667,928, filed on Apr. 4, 2005.

(51) Int. Cl. G06F 17/00; G07B 15/02

(52) U.S. Cl. 235/375; 235/384

(57) ABSTRACT

In one embodiment, the disclosure relates to a method for providing a customer with repair information for a vehicle at a point of service. The method includes (1) identifying the vehicle by using a vehicle identifier, the vehicle identifier defined by at least one of a vehicle identification number, manufacturer, model, year of production and owner; (2) identifying a preliminary assessment of the vehicle; (3) providing a first presentation, the first presentation defined by at last one of the vehicle identifier, a vehicle repair history and the preliminary assessment of the vehicle; (4) providing a second presentation, the second presentation directed to a recommended service plan; (5) each of the first presentation and the second presentation allowing the customer to select or decline one or more services offered by each presentation; and (6) identifying a customer-declined service and providing the customer at least one of a reminder or an incentive for future use of the declined service.

The instant application claims the filing-date priority of the provisional Application No. 60/667,928 filed Apr. 4, 2005, the specification of which is incorporated herein in its entirety.

### BACKGROUND

Vehicle Identification Number (“VIN”) has been extensively applied to tracking service history and repair information of a vehicle. One advantage of using VIN to identify and track the vehicle's repair history is that the history can be traced back to the vehicle's purchase. Another advantage is that the repair history is associated with the vehicle and remains a property of the vehicle regardless of changes in ownership. Still another advantage is the vehicle's cumulative repair history can be nationally available. That is, the vehicle history can be retrieved from a nationally-available database from any local or regional repair station.

Conventionally, vehicles are received at the dealer's service station by a service representative who will record the vehicle information and the driver's service request on a service order. The service order is used to communicate the service request to the mechanic as well as to retrieve pertinent repair history as discussed above. Upon completion of the repair, a copy of the service order including all charges are forwarded to the customer and used as a receipt.

The service order is conventionally prepared by a service representative who greets the customer at the point of service (i.e., upon arriving at the service department of a dealership). The service representatives are often the only contact point with the customer. Consequently, they are instructed to promote and sale other available services, such as maintenance and enhancement services, to the customer at point of service. While the service representative can explain and promote the additional services, intangibles such as poor presentation skills, lacking product knowledge and a lack of time often prevent securing sales. To address this problem, dealers spend much effort motivating and providing tools for improving the service representative's performance. However, such efforts have been proven mostly futile.

Besides the fact that there is very little time to present additional services (3-7 minutes on average), the service representative is typically away from his work-station and does not have access to the written promotional material. Even of promotional material is distributed to the customer, the customer is unlikely to have time to review the promotional material and make a purchase decision. Thus, the promotional material is often discarded which makes it difficult to secure sales on additional services or to demonstrate the benefits of the proposed services. Other attempts such as using banners, brochures and point-of-service displays have also proven futile as the critical time to present and get acceptance for the additional services is when the service representative is preparing the repair order.

### SUMMARY

According to one embodiment, the service representatives are supplied with apparatus adapted to, among others, receive vehicle's preliminary information, provide a multi-media presentation of promotional programs to the customer, provide a multi-media presentation of customized dealer-specific promotions and provide factory-directed communications to the customer.

In another embodiment, customer's information and the presentation results are stored for future reference and/or for providing additional promotional material to the customer at a later time through different mediums.

In still another embodiment, the disclosure relates to a wireless apparatus for assisting and directing the service providers at the point of service. The apparatus may include a wireless system for real-time communication of vehicle information with a local or a national network. The apparatus may also include means for communicating vehicle-specific promotional advertising to the customer at the point of service.

In still another embodiment, the disclosure relates to a method for providing a customer with repair information for a vehicle at a point of service. The method includes (1) identifying the vehicle by using a vehicle identifier, the vehicle identifier defined by at least one of a vehicle identification number, manufacturer, model, year of production and owner; (2) identifying a preliminary assessment of the vehicle; (3) providing a first presentation, the first presentation defined by at last one of the vehicle identifier, a vehicle repair history and the preliminary assessment of the vehicle; (4) providing a second presentation, the second presentation directed to a recommended service plan; (5) each of the first presentation and the second presentation allowing the customer to select or decline one or more services offered by each presentation; and (6) identifying a customer-declined service and providing the customer at least one of a reminder or an incentive for future use of the declined service.

In another embodiment, the disclosure relates to an apparatus for providing enhanced services at a point of service for a vehicle repair center. The apparatus can include a communication devices having one or more circuitry programmed with instructions to (1) identify the vehicle by using a vehicle identifier, the vehicle identifier defined by at least one of a vehicle identification number, manufacturer, model, year of production and owner; (2) identify a preliminary assessment of the vehicle; (3) provide a multi-media presentation as a function of the vehicle identifier, a vehicle repair history and the preliminary assessment of the vehicle; (4) allow the customer to select or decline one or more services offered by each presentation; and (5) identify a customer-declined service and providing the customer at least one of a reminder or an incentive for future use of the declined service.

### BRIEF DESCRIPTION OF THE FIGURES

These and other embodiment of the disclosure will be illustrated with reference to the following non-limiting drawings in which:

FIG. 1 is a schematic representation of an apparatus according to one embodiment of the disclosure; and

FIG. 2 is an exemplary diagram representing a method according to one embodiment of the disclosure.

### DETAILED DESCRIPTION

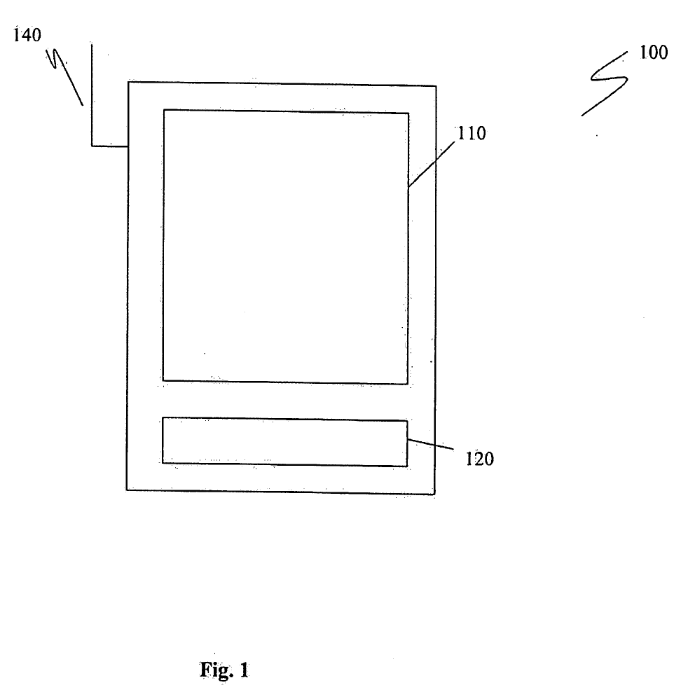

FIG. 1 is a schematic representation of an apparatus according to one embodiment of the disclosure. Specifically, FIG. 1 shows apparatus 100 (interchangeably, tablet 100) which can be configured according to an embodiment of the instant disclosure. Apparatus 100 can be a PDA, a portable computer or a portable computer tablet for direct interface with the user. Apparatus 100 is shown to have communication screen 110, input receiver 120 and antenna 140. Screen 110 may include a conventional LCD or plasma screens. In one embodiment, screen 110 is a touch-pad capable of on-screen communication through a magnetic pen or similar devices.

Input 120 may include a key board, or a secondary screen adapted for on-screen communication or one or more I/O ports. Additionally, apparatus 100 may include speakers and/or microphone for voice communication. Antenna 140 enables wireless communication between apparatus 100 and a local Ethernet or an internet infrastructure. While apparatus 100 is shown with antenna 140, the embodiments of the disclosure are not limited thereto and apparatus 100 can be adapted to communicate through land-line or other communication modes.

For ease of access, apparatus 100 can be made portable such that a service representative can transport the apparatus to the point of service. According to one embodiment, apparatus 100 is programmed with software to interactively receive information from the customer, retrieve vehicle information, create a service order, present a multi-media presentation of additional services to the customer, provide the customer with dealer-specific menus and warn customer of outstanding factory recalls or campaigns. Apparatus 100 is further adapted to readily retrieve vehicle history report, record customer's selection and direct future communications to customer in view of the customer's particular selections.

Apparatus 100 may include one or more processors programmed with instructions to accomplish several distinct tasks. The tasks (interchangeably, sub-routines) can be devised to optimize the time allotted to each customer at the point of service. For example, the processor can be programmed with sub-routine to initiate a vehicle inspection screen to begin customer processing. The vehicle inspection screen can include the questions traditionally present in the service order. In an exemplary embodiment, the vehicle inspection screen request entry of the vehicle's identification number. The vehicle identification number can be manually entered by using a magnetic pen to directly communicate with screen 110 or by using a keyboard. Alternatively, a scanner can be used to scan the VIN and communicate the results to tablet 100 through I/O port (not shown) or through antenna 140.

Once the VIN is identified, the software can automatically retrieve the vehicle's repair history as well as any other pertinent vehicle information (e.g., outstanding recalls or dealer-specific promotions) for the vehicle. The retrieval can be done through wireless communication with a local or a national network. Alternatively, apparatus 100 can include a local database for storing pertinent information.

The vehicle inspection screen (or sub-routine) enables the service representative or the customer to enter information about the condition of a vehicle such as body damage, tire wear, brake condition, vehicle fluid condition, etc. The routine can be interactive such that the customer can view the information directly form the tablet and sign to accept or decline a proposed service. This process is typically overlooked by most service writers due to time restraints or simple apathy and is a valuable tool for identifying sales opportunities. The embodiment disclosed herein can force the service writer to complete the process before going to the next step.

Once the basic information has been identified in the vehicle inspection screen, the customer can be presented with a multi-media presentation. The presentation can be implemented through the tablet and may include audio-video discussion of information pertaining to the services. The presentation can be interactive thereby requiring the customer's input. For example, to assist in explaining the features and benefits of a service, the service representative (or the customer) can click to open an “info” commercial for the service and let the customer view it on the driveway or in his vehicle. Alternatively, an informational commercial can be selected by the processor given the customer's criteria. For example, if a customer's vehicle has overly worn tires, an infomercial may be presented that advertises a tire change. If a customer's vehicle has exhausted air-conditioning fluid, an infomercial may be presented that advertises evacuation and recharge of air-conditioning fluid. Or if a customer's vehicle has a cracked window, an infomercial may be presented that advertises window repair or replacement. Typically, most service representatives do a poor job of presenting the benefits of a service and as a result the customer does not purchase additional services. The presentation eliminates the “human” element and provides all the key information in a quick entertaining manner.

Another important aspect of the presentation is that it can be specifically tailored to the customer's need. For example, once the VIN is identified and the customer's repair history has been verified, a multi-media presentation that closely matches one or more of the customer's vehicle, repair history, demographic information, hobbies or other purchase habits can be retrieved and presented to the customer. To this end a number of presentations can be prepared and stored on the tablet's memory, or alternatively, can be retrieved from an offsite database. Since the presentations are specifically designed to the customer's immediate or future needs, they are non-repetitious and more likely to elicit a purchase.

Another exemplary sub-routine is the customized dealer-specific menus. Vehicle manufacturers recommend specific maintenance procedures at certain mileage intervals. For example, Toyota Corporation recommends an intermediate service to be performed every 15,000 mile on its vehicles. However, the content of the “15K” service varies depending on the dealer, location, driving habits and the vehicle's make and model. Therefore, a customized menu can be created that clearly lists all such maintenance services by make, model, mileage and dealer recommendations. Such a menu gives a clear and concise tool for the service representative to use for explaining the available services. The customer may then accept or decline through the user interface of the tablet. Without such menu program, errors and omissions are common. There also tends to be miscommunications which may lead to lower customer satisfaction.

Still another exemplary sub-routine is the dealer-factory interface. The dealer-factory interface identifies any outstanding recall or campaign based on make and model of the vehicle. Such recalls and campaigns may be unknown to the customer and affect the vehicle's safety and performance. With the vehicle information such a VIN #, year, make and model, apparatus 100 can access information from vehicle manufacturer about any outstanding recalls and inform the customer accordingly. Without this feature, service representative and even the customer may forget or ignore this important step. This step can also include advising the customer of additional or complementary services.

Another exemplary sub-routine is the follow-up and reminder sub-routine. In the event that the customer declines a recommended service, this system stores the information on the dealer's database by assigning an “Op” code to flag the event. The dealer can then run a report from their dealer management system (“DMS”) and create a marketing or advertising campaign that will send information on the declined services to the customer by telephone, mail or email. The customer can also receive coupons or other incentives for the declined services or for future services. This information can also be stored in “History” files so it can be accessed and referenced during the customer's next visit. These steps can be implemented electronically and without creation of additional paper-work for the service representative or the dealership.

Yet another exemplary sub-routine will allow automotive repair facilities to send important vehicle information electronically via e-mail, text messaging, voice broadcasting and/or text-to-speech messages while they are “writing up” the customer for services. These electronic communications may be sent either to the customer or to third-party service vendors such as body shops, glass repair shops etc.

Electronic Communications sent to the customer may expedite and improve the service process by providing the customer with important updates on their vehicle and electronic records pertaining to their car. When a customer signs a service invoice, recommendation or finding, in paper or electronic form, this may be automatically e-mailed to the customer. These records may be crucial for warranty reasons, trade-in value, or resale value. Currently, service recommendations and findings are only supplied in printed form. However, printed materials may be easily lost or damaged over time. Electronic records may be easily maintained by customers for future reference.

Electronic communications (e-mails, text messages, etc.) sent to third-party vendors may assist the customer with additional repair needs and create additional profit opportunities for automotive repair facilities. With the customer's approval, this sub-routine may allow the service center to send pictures, electronic documents and detailed service information to third-party vendors. This may improve the overall experience for the customer by providing an integrated web of services.

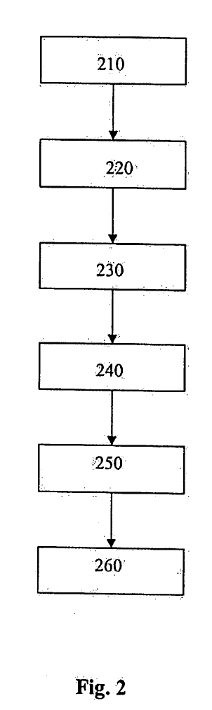

FIG. 2 is an exemplary diagram representing a method according to one embodiment of the disclosure. In particular, the block diagram of FIG. 2 represents the structure of an exemplary sub-routine for tablet 100. In step 210, the vehicle's VIN is scanned and the pertinent information (e.g., ownership and repair history) is retrieved. In step 220, the vehicle inspection sub-routine is engaged and the customer is instructed interactively to provide the desired repair information. Either at the end of step 220, or simultaneously therewith, a presentation specifically devised for the customer is retrieved. In step 230 a multi-media presentation is offered for the customer's viewing. Optionally, this step can be waved or combined with another step. Next, dealer-specific menus can be presented at step 240; followed by step 250 which may include the factory interface information. Step 260 may include an internal sub-routine to record the session and prepare follow-up reminders and offers. The sub-routines presented herein are exemplary and can be implemented in any other order.

The specific embodiments presented herein are exemplary in nature and are not intended to limit the scope of the disclosure. Any permutation, modification and deviation from the specific embodiments are considered to be well within the scope of the principles disclosed herein.

What is claimed is:

1. A method for providing a customer with repair information for a vehicle at a point of service comprising:
identifying the vehicle by using a vehicle identifier, the vehicle identifier defined by at least one of a vehicle identification number, manufacturer, model, year of production and owner;
identifying a preliminary assessment of the vehicle;
providing a first presentation, the first presentation defined by at last one of the vehicle identifier, a vehicle repair history and the preliminary assessment of the vehicle;
providing a second presentation, the second presentation directed to a recommended service plan;
each of the first presentation and the second presentation allowing the customer to select or decline one or more services offered by each presentation; and
identifying a customer-declined service and providing the customer at least one of a reminder or an incentive for future use of the declined service.

2. The method of claim 1, wherein the step of identifying the vehicle further comprises scanning the vehicle identification number.

3. The method of claim 1, wherein the step of identifying the vehicle further comprises scanning a bar code associated with the vehicle.

4. The method of claim 1, wherein the preliminary assessment of the vehicle is readily accessible to the customer.

5. The method of claim 1, wherein the preliminary assessment of the vehicle is provided to the customer by electronic transmission.

6. The method of claim 1, wherein the preliminary assessment of the vehicle includes identifying the condition of the vehicle tires, brakes, fluids and structural conditions.

7. The method of claim 1, wherein the first or the second presentation is made at the point of service.

8. The method of claim 7, wherein the first and the second presentation is made interactively requiring customer's input.

9. The method of claim 1, wherein the step of providing a first or second presentation further comprises selecting an appropriate presentation as a function of the vehicle identifiers or as a function of secondary factors.

10. The method of claim 9, wherein the secondary factors include the customer's demographic information, hobbies or purchase habits.

11. The method of claim 1, wherein the second presentation includes services directed to a vehicle recall or services devised by a manufacturer.

12. The method of claim 1, wherein at least one of the first or second presentations is further devised to include a promotional campaign.

13. The method of claim 1, further comprising electronically notifying the customer of a future promotional campaign for the declined service.

14. The method of claim 1, further comprising sharing the preliminary vehicle assessment with a third party.

15. An apparatus for providing enhanced services at a point of service for a vehicle repair center, the apparatus comprising:
a multi-media communication devices having one or more circuitry programmed with instructions to
identify the vehicle by using a vehicle identifier, the vehicle identifier defined by at least one of a vehicle identification number, manufacturer, model, year of production and owner;
identify a preliminary assessment of the vehicle;
provide a multi-media presentation as a function of the vehicle identifier, a vehicle repair history and the preliminary assessment of the vehicle;
allow the customer to select or decline one or more services offered by each presentation; and
identify a customer-declined service and providing the customer at least one of a reminder or an incentive for future use of the declined service.

16. The apparatus of claim 15, wherein the step of identifying the vehicle further comprises at least one of scanning the vehicle identification number or scanning a bar code associated with the vehicle.

17. The apparatus of claim 15, wherein the preliminary assessment of the vehicle is provided to the customer by electronic transmission.

18. The apparatus of claim 15, wherein the multi-media presentation is made interactively requiring customer's input.

19. The apparatus of claim 15, wherein the step of providing a multi-media presentation further comprises selecting an appropriate presentation as a function of at least one of the customer's demographic information, hobbies or purchase habits.

20. The apparatus of claim 15, wherein the second presentation includes services directed to a vehicle recall or services devised by a manufacturer.

21. The apparatus of claim 15, further comprising sharing the preliminary vehicle assessment with a third party.

22. The apparatus of claim 15, further comprising a transceiver for radio communication with a server.

23. A method for interactively assisting a customer with a vehicle repair process at a point of service, the method comprising:
identifying the vehicle by scanning a bar-code associated with the vehicle to identify the vehicle by at least one of a vehicle identification number, manufacturer, model, year of production or owner;
conducting a preliminary assessment of the vehicle's condition and recording said condition;
providing a customer presentation for offered services, the presentation configured as a function of at last one of the vehicle identifier, a vehicle repair history and the preliminary assessment of the vehicle, the presentation further comprising a recommended service plan, a manufacturer recall, a dealer campaign or a promotional campaign, the presentation interactively allowing the customer to select or decline one or more services offered by each presentation; and
identifying a customer-declined service and providing the customer at least one of a reminder or an incentive for future use of the declined service.

24. The method of claim 23, further comprising providing a written contract identifying any service selected by the customer.
